(19) United States
(12) Patent Application Publication
(10) Pub. No.: US 2015/0188756 A1
(43) Pub. Date: Jul. 2, 2015

(54) SYSTEMS AND METHODS FOR INDICATING EVENTS OF INTEREST FROM A SERVER

(71) Applicant: Sonic IP, Inc., Santa Clara, CA (US)

(72) Inventors: William Amidei, La Jolla, CA (US); Francis Chan, San Diego, CA (US); Eric Grab, San Diego, CA (US); Michael Kiefer, Lake Havasu City, AZ (US); Aaron McDaniel, La Mesa, CA (US); John Mickus, San Marcos, CA (US); Ronald Mombourquette, San Diego, CA (US); Nikolai Popov, Tierrasanta, CA (US); Fred Zuill, Poway, CA (US)

(73) Assignee: DivX, LLC, Santa Clara, CA (US)

(21) Appl. No.: 14/144,054

(22) Filed: Dec. 30, 2013

(51) Int. Cl. H04L 12/24; G06N 99/00; G06N 5/02; H04L 29/08

(52) U.S. Cl. CPC H04L 41/0686; H04L 67/10; H04L 67/16; H04L 67/306; G06N 99/005; G06N 5/027

(57) ABSTRACT

Methods and systems to indicate events of interest to a user. IN an embodiment, an event processor queries each of a plurality of event data sources, then receives event data from one or more event data source. The event processor then identifies an event to be indicated to a user device based on the event data. The identified event to the user through a user device. The event processor may receive, via the user device, feedback regarding the identified event. This feedback may be used to train future event identification. The event processor may be implemented at a computing device that is remote from the user, such as a server. Alternatively, the event processor may be implemented internal to the user device.

### BACKGROUND

At any particular time, a person may have a variety of events or social gatherings in which he may participate. Concerts, movies, or sporting events might be available in the coming days or weeks; television broadcasts of particular programs will be available; parties or other social gatherings may be planned by him or by others.

In order to be aware of all the events and gatherings of possible interest to him, a person would have to research all events of possible interest, and record their times and locations. He would have to learn of such events, and have the diligence to schedule them on a personal calendar of some sort. Moreover, in the course of doing such research, the person would have to sift through all available events and ignore those that are not of interest to him. For most people, the vast majority of available events will be of little or no interest. People generally have a few favorite musical genres and musicians, so most upcoming concerts would not be of interest. Likewise, most sports teams may not be of interest, and most television programs would not be worth noting. Moreover, the research would have to be repeated at some frequency if the person wished to stay abreast of upcoming events.

In addition, a person's consideration of an upcoming event may hinge on multiple factors. Timing, location, and social context may be important. A person may want to see a particular concert, but not if it conflicts with his bowling night. He may be interested in a new foreign film, but would be less interested if the film were only being screened at one theater 40 miles away. He might have minimal interest in Karaoke Night at Fritz's Tavern, but may be quite interested if several friends were planning to go.

It is therefore difficult for a person to be aware of the variety of events available to him without having to do considerable research on a regular basis. Moreover, to establish a calendar of interesting events, the research would need to be coupled with some evaluation of possible events where the evaluation is informed by additional factors.

### BRIEF DESCRIPTION OF THE DRAWINGS/FIGURES

FIG. 1 is a block diagram illustrating the system described herein as implemented in a server, according to an embodiment.

FIG. 2 is a block diagram illustrating the system described herein as implemented in a user device, according to an embodiment.

FIG. 3 is a flow chart illustrating the processing described herein according to an embodiment.

FIG. 4 is a flow chart illustrating an event identification process, according to an embodiment.

FIG. 5 illustrates a node for event evaluation in a neural network embodiment.

FIG. 6 illustrates a node for evaluation of an associate in a neural network embodiment.

FIG. 7 illustrates a user interface for displaying events, according to an embodiment.

FIG. 8 illustrates a user interface for parameter adjustment, according to an embodiment.

FIG. 9 illustrates a user interface according to an alternative embodiment.

FIG. 10 illustrates a computing environment at a server, according to an embodiment.

FIG. 11 illustrates a computing environment at a user device, according to an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are methods and systems to indicate events of interest to a user. In an embodiment, an event processor queries each of a plurality of event data sources, then receives event data from one or more event data source. The event processor then identifies an event to be indicated to a user device based on the event data. The identified event is conveyed to the user through the user device. The event processor may receive, via the user device, feedback regarding the identified event. This feedback may be used to train future event identification. The event processor may be implemented at a computing device that is remote from the user, such as a server. Alternatively, the event processor may be implemented internal to the user device.

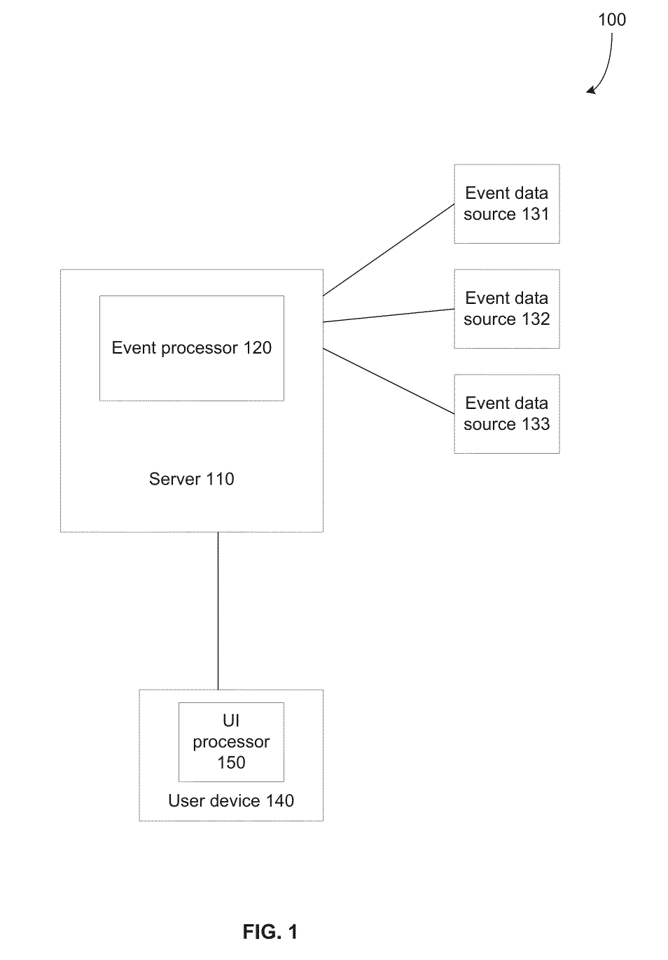

FIG. 1 illustrates an embodiment where the event processor is located at a server that is remote from a user device. Server 110 is shown as having an event processor 120. Server 110 is in communication with a user device 140. The user device 140 includes a user interface (UI) processor 150 that is responsible for presenting information to the user and for allowing the user to provide feedback regarding events identified by the event processor 120. The user device 140 may be at a stationary or portable computing device, such as a desktop personal computer, a lap top computer, a tablet computer, a smart phone, a wearable computer, or other computing device. The server 110 may be any programmable computing device that includes communications capabilities, as would be understood by a person of ordinary skill in the art.

The server 110 is in communication with one or more event data sources 131-133. While three event data sources are show, it is to be understood that more or fewer event data sources are possible in alternative embodiments. These data sources represent information services that supply information regarding upcoming events. Such events may include entertainment events, such as concerts, films, plays, television broadcasts, and sporting events, for example. These event data sources may be accessible over the Internet. Examples may include broadway.com, ticketmaster.com, mlb.com, xfinity.comcast.net, HBO.com, and meetup.com. Upcoming events may also be social events, such as gatherings of friends, happy hours, parties, etc. Therefore, social media sites may also serve as event data sources. These may include Facebook, LinkedIn, and Twitter, for example.

Communications between the server 110 and event data sources 131-133, and between the server 110 and user device 140, may take place using any infrastructure and protocols known to persons or ordinary skill in the art, including those embodied in the Internet.

As will be described in greater detail below, the server 110 may query the event data sources 131-133. These data sources respond by providing data regarding upcoming events to the server 100. In other embodiments, event data may be provided to the event processor without an explicit query. Event data may include a variety of parameters, such as the nature of the event (e.g., concert, sporting event, happy hour, etc.), the location of the event, the time of the event, the names of any performers or participants at the event, and the cost of attending the event. This list of parameters is not meant to be limiting; additional and/or alternative parameters may be used in alternative embodiments.

The event processor 120 may then identify events that may be of interest to the user. Such events may be conveyed to the user device 140 and indicated to the user. In an embodiment, this identification process may take advantage of a known profile of the user, where such a profile specifies entertainment and/or social preferences of the user. Such preferences may include the kinds of music preferred by the user, particular artists that the user enjoys, particular kinds of films, particular sports, preferred recreational activities, etc. The user profile may also specify, for a given type of event, the amount of money that the user may be willing to spend to see an event, and the distance he may be willing to travel to see an event. In some embodiments, the user profile may also specify particular friends with whom the user may wish to socialize. Such parameters may then be used by the event processor 120 to identify particular events that would be of interest to the user.

Once the identified events are shown to the user, the user may provide a reaction back to the event processor 120. Such a feedback may include an adjustment of one or more of the parameters. He may decide, for example, that he is not as willing to travel as he previously thought; he may decide that he now prefers basketball over hockey; he may decide that he would now rather attend a symphony concert rather than a bluegrass concert. Such changes in preferences would then be conveyed to the event processor 120. Alternatively, or in addition, the user's reaction may be binary—he may simply indicate an acceptance or rejection of an identified event. As will be described in greater detail below, such reactions by the user is may be used to inform and adjust future event identifications.

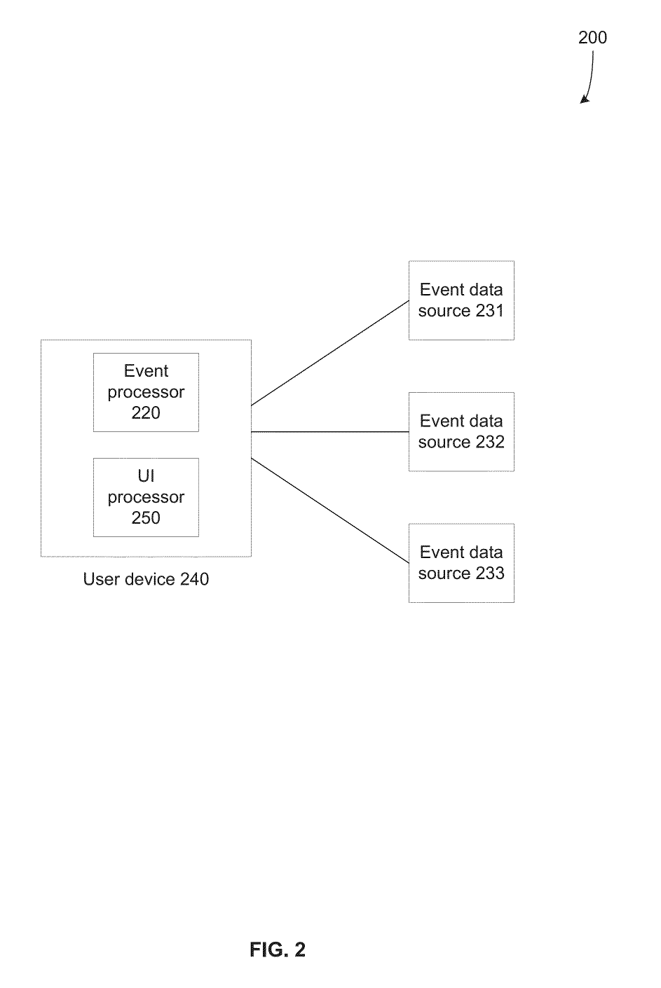

In an alternative embodiment, the event processor may be located at the user device. Such an embodiment is illustrated in FIG. 2. Here, the user device 240 is in direct communication with event data sources 231-233. As in the previous case, there may be more or fewer that three event data sources in alternative embodiments. The user device 240 includes a user interface (UI) processor 250 that is responsible for presenting information to the user and receiving feedback. As in the previous embodiment, the user device 240 may be a stationary or portable computing device, such as a desktop personal computer, a lap top computer, a tablet computer, a smart phone, a wearable computer, or other computing device.

The user device 240 includes the event processor 220. The user device 240 may query the event data sources 231-233. These data sources may respond by providing data regarding upcoming events to the user device 240. In other embodiments, an explicit query may not be necessary to receive event data from a data source. The event processor 220 can then identify events that may be of interest to the user in the manner discussed above with respect to FIG. 1. Such events may be conveyed to the user device 240 and indicated to the user. In an embodiment, this event identification process may take advantage of a known profile of the user, in a manner similar to that of the previous embodiment.

Once the identified events are shown to the user, the user may provide a feedback to the event processor 220. Such a reaction may include an adjustment of one or more of the parameters. Alternatively, the user's reaction may be binary—he may indicate an acceptance or rejection of an identified event, as discussed above. As will be described in greater detail below, such reactions by the user may be used to inform and adjust future event identifications.

Communications between the user device 240 and the event data sources may take place using any infrastructure and protocols known to persons or ordinary skill in the art, including those embodied in the Internet.

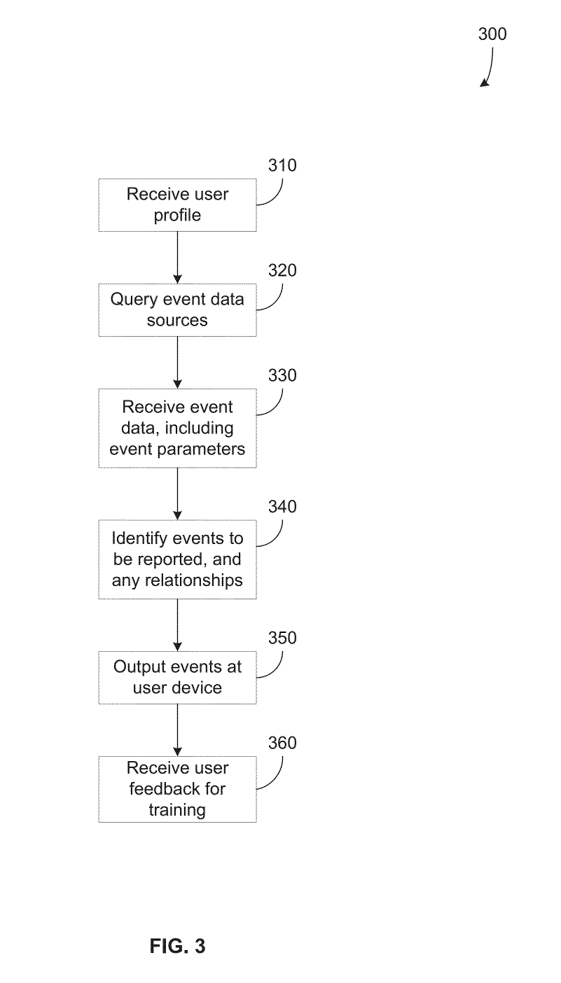

Processing of the systems described herein is illustrated in FIG. 3, according to an embodiment. At 310, a profile of the user is received. The user profile includes preferences of the user, where these preferences can be used to identify events of interest to the user. The preferences may describe the user's tastes in music (such as preferred genres, composers, artists, etc.), film and television (such as favorite directors, actors, etc.), sports (such as college or professional, particular teams and athletes, etc.), and may identify preferred social contacts (i.e., friends), for example and without limitation.

The profile may originate in any of several ways. In an embodiment, the user may be asked to complete a questionnaire through which he states his preferences. Alternatively, the user's preferences may be inferred through analysis of other available data, such as online purchasing records. Such records would reveal the kinds of music he has downloaded, the kinds of movies he has rented, the events for which he has bought tickets, etc. Lists of friends may also be identified from email address books and social media contact lists, for example.

At 320, event data sources are queried. As described above, these data sources may be online repositories of information regarding upcoming events. For any given event, the associated event data would typically include several parameters, such as the date and time of the event, the location of the event, the cost to see the event, and category and genre information regarding the event (e.g., sport, concert, film, or television; music, drama, or comedy). At 330, the event data, including these parameters, is received. In alternative embodiments, a query process may not be necessary; in such an embodiment, event parameters may be sent to an event processor as a matter of course, without requiring an explicit query. A subscription arrangement may be used to accomplish this, for example.

At 340, the event processor identifies events to be reported to the user. As noted previously, this identification process may be based on known preferences of the user. The event identification process will be discussed in greater detail below.

In addition, relationships between identified events are also flagged for the user in the illustrated embodiment. Such relationships may be based on parameters that are common to events. If two sports events are identified to the user, and both include the same team, a relationship may be shown to the user. If a happy hour and a karaoke night are both taking place at the same tavern on different nights, a relationship may be shown to the user. If these two events are taking place at different locations, but both will be attended by the user's friends, then a relationship may be reported to the user. If a certain actor appears in both an upcoming television program and an upcoming movie, a relationship may be shown to the user. These examples are illustrative, and are not intended to be limiting.

At 350, identified events are output. In the case where the identification process takes place at an event processor at a remote server, the output is sent to the user's device and conveyed to the user. If the event processor is incorporated at the user device, then the identified events are presented directly to the user.

At 360, feedback from the user may be received. This may take any of several forms. A user may, for example, reject an identified event. Despite an identification process that may have been informed by the user's preferences, the user may not like the identified event. In this case, the identification process did not yield a desirable result, and this failure is fed back into the identification process. Where the event identification process employs artificial intelligence techniques, this feedback is used to train this process to improve future event identifications. Analogously, the user may approve the identified event. This approval may also be used as feedback.

In other embodiments, the feedback from the user may be more specific than a binary response. The user may, for example, adjust particular preferences. If he previously stated that he liked baseball and rated it with the number 8 on a preference scale of 1 to 10, he may find that too many baseball games are being identified. He may then provide feedback by changing his rating of baseball from 8 to a rating of 6. Where he previously preferred pop music over country music, he might change this to prefer country. Such updated information can then be fed back to the event processor for training purposes, thereby affecting future event identifications.

In an alternative embodiment, the receipt of a user profile (310) may not occur. Instead, the user feedback (360) may be used to tailor or train the event identification process, so that future iterations of this process yield events that are increasingly relevant to the user.

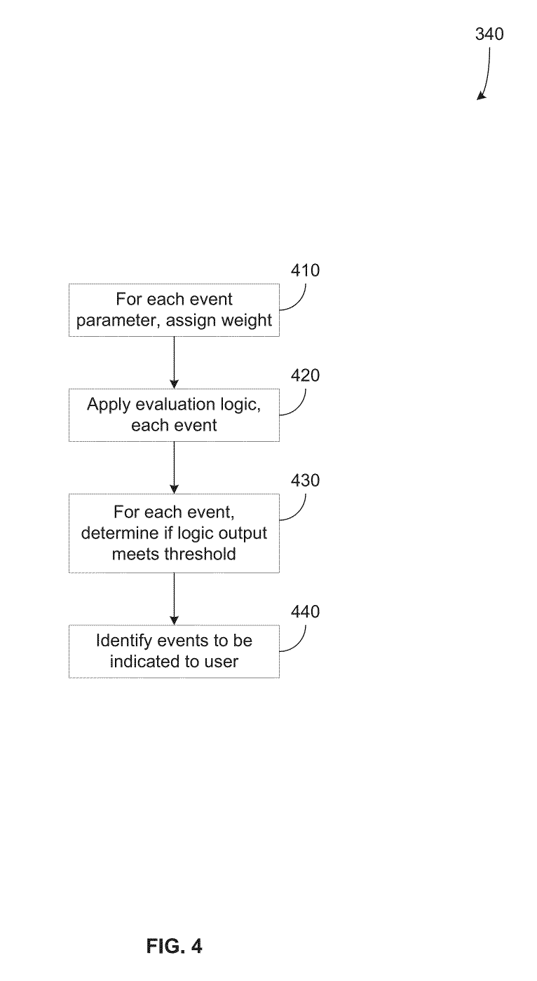

The event identification of 340 is illustrated in FIG. 4, according to an embodiment. At 410, each event parameter of each known event is assigned a weight. The weight may be assigned on the basis of the user's preferences for example. In the absence of a user preference, the weight may be given an arbitrary value initially. At 420, evaluation logic is applied to the weighted parameters. In an embodiment, the evaluation logic may comprise a quantification of the parameters and a function that combines the quantified parameters, taking into account their weights. Alternatively or in addition, the evaluation logic may include artificial intelligence and rule-based processing to evaluate events in view of the user's preferences.

In an embodiment, the evaluation logic may be implemented using an artificial neural network, where the evaluation logic for an event takes place at one or more interconnected nodes. In such an embodiment, event parameters and their weights may serve as inputs to the node(s). At 430, a threshold test is applied to the result of the evaluation logic. In the context of a neural net implementation, this threshold test may be used to determine if the node fires. If so, event(s) corresponding to the firing node(s) may be identified for the user at 440.

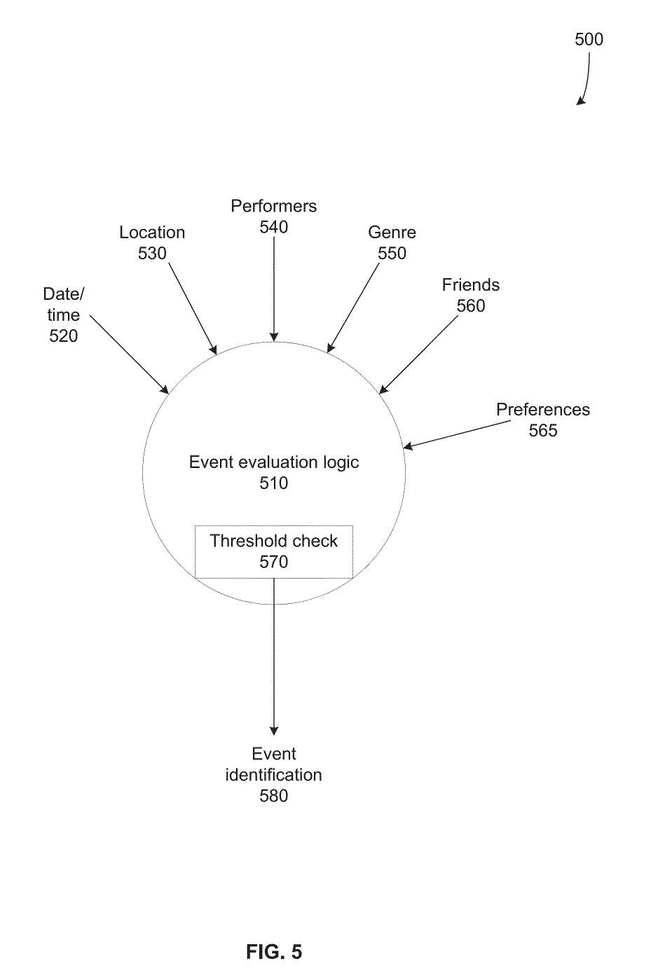

An example of a neural network node that represents an event is illustrated in FIG. 5, according to an embodiment. Evaluation logic 510 receives a number of inputs, as shown. The example inputs include the date and time of the event (input 520), the event's location 530, the performers at the event 540, a classification and/or genre of the event (input 550), and any friends of the user who are attending the event (input 560). User preferences 565, originating from a user profile and/or user feedback, may also be input. As noted above, some or all of the inputs may be quantified and/or weighted. The result of the evaluation logic 510 is then checked to determine if a threshold test is met at module 570. If so, then the node fires, outputting an event identification.

Training of a neural network implementation may take place as a result of feedback provided by the user. A rejection of an identified event by the user may indicate that similar events should be treated by the neural network as being less desirable. More detailed feedback may also be used. The user's adjustment of his preferences may be used in altering the weighting of certain parameters or in otherwise revising the logic 510. Such training would allow for more accurate identification of events that suit the user.

As would be understood by a person of ordinary skill in the art, the nodes relating to an event may be interconnected, so that the outputs of some nodes are inputs to others. Whether a given event is identified for a user may depend, for example, on whether another event represented by another node is taking place at the same time. In the event of a time conflict, one event may take precedence, so that the node representing the other event should not fire. In another example, the user may not want to attend similar events in consecutive days, or may not want to see a given acquaintance too many times in one week. Such considerations may be implemented by interconnecting the nodes representing such events. These scenarios are intended as examples, and are not meant to be limiting.

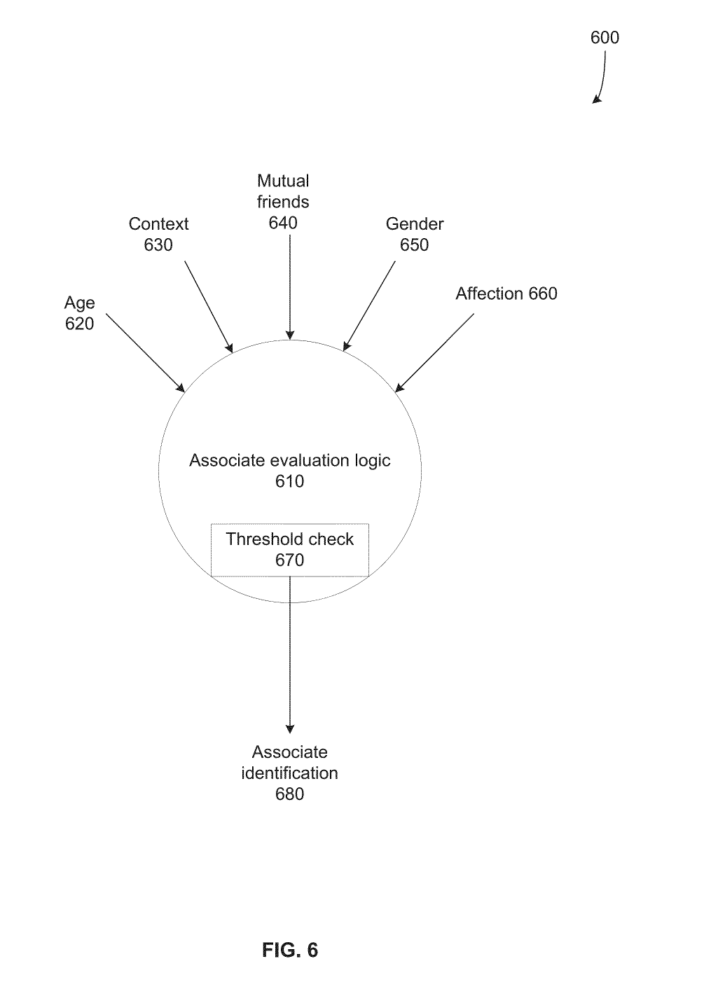

A relationship between the user and an acquaintance may also be represented as a node, as shown in FIG. 6 according to an embodiment. Such a node may be useful when determining the value of an associate's presence at a given event, for example. An event may be more attractive (or less attractive) to the user if certain person(s) are also present. In the example of FIG. 6, associate evaluation logic 610 uses a variety of possible inputs. These may include the age of the associate (input 620), the context 630 of the association (e.g. work, family, neighbor, etc.), whether there are mutual friends between the user and the associate (input 640), the associate's gender 650, and a level of affection for the associate (input 660).

As in the case of the event evaluation node, the inputs may be quantified and weighted, and numerical and/or rule-based processing maybe applied in combining the inputs. The result may then be subjected to a threshold test 670 to determine if the node fires to produce an associate identification 680.

The associate identification 680 may serve as an input to an event evaluation node. The presence of absence of the associate in the event may be relevant in determining whether the event is to be identified for the user. Moreover, information related to the associate, including some or all of the inputs to the associate evaluation logic 610, may also be used as inputs to the event evaluation node. As an example, associate's context 630 may be relevant. An event, such as a happy hour, may be more desirable if associates from work will be present. Other events, such as a karaoke night, may be less desirable if coworkers are there. In another example, an event may become more (or less) attractive if an associate of the opposite gender (see input 650) is present.

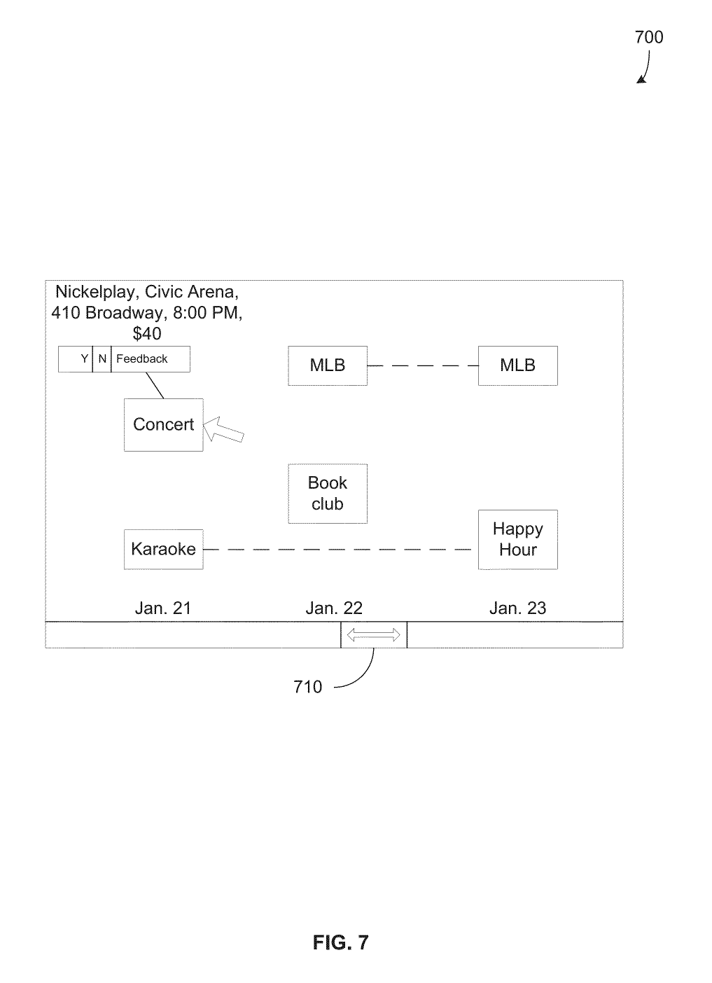

An example of a user interface is shown in FIG. 7, according to an embodiment. This UI shows a variety of events according to their dates, and therefore represents an event timeline or horizon for the user. On January 21, a karaoke event and a concert are identified to the user. As described above, such events are shown to the user after having been identified on the basis of the user's preferences and other factors. On January 22, a book club meeting is shown, along with a major league baseball (MLB) game. On January 23, a happy hour is available, along with another MLB game. In the illustrated embodiment, the interface can be navigated by horizontally scrolling, using a control such as slider 710. This allows the user to see events identified for future dates.

If the user clicks on an event, such as the concert, some of the event parameters are displayed in the illustrated embodiment. Here, clicking on the concert reveals that the artist is the band Nickelplay, performing at 8:00 PM at the Civic Arena, located at 410 Broadway.

In addition, an opportunity for feedback is presented to the user in the illustrated embodiment. The user may accept or reject the event by clicking on Y or N. The user is also given the opportunity for more detailed feedback, by clicking on the feedback button. A user interface for such feedback will be discussed below.

Note that some events are related, as shown on the UI by the dashed line. The karaoke event and the happy hour are related because of some common parameter(s). For example, some of the user's friends may be attending each, or the events may be taking place at the same location. The two MLB games are also shown as being related. This may be because the games are being played at the same venue, or because the same teams are playing in each game, for example. In an embodiment, the nature of the relationship is shown to the user when he clicks on either of the related events.

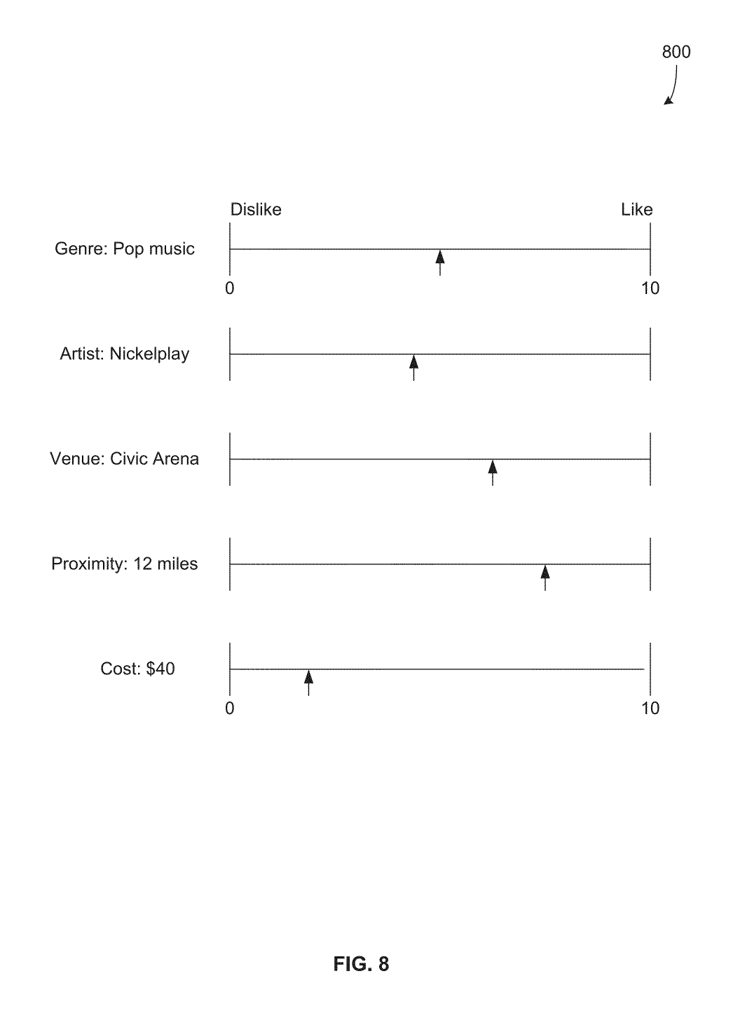

User feedback can also be provided through a UI such as that shown in the embodiment of FIG. 8. The UI 800 provides a set of sliders with which the user can define or adjust a set of exemplary preferences. The user can adjust any of the parameters shown in reaction to an identified event. In the case of the Nickelplay concert, the user can adjust his stated preference for the pop music genre and the band itself. The user can also change his like or dislike of the venue and its proximity to the user. The user can also state the degree to which he likes or dislikes the ticket cost. Using the feedback provided through such a UI, the event evaluation logic may be trained or retrained to identify future events that better suit the user. In an embodiment, a similar UI may be employed to query the user initially and create a user profile.

In an alternative embodiment, the user is able to browse various events over time, compare them to each other, and discover other events related to those identified by the system above. In so doing, a score or weight may be generated for each event. Such a weight may be generated by the evaluation logic 510 of FIG. 5. As a result, the events have respective weights that can be compared to each other.

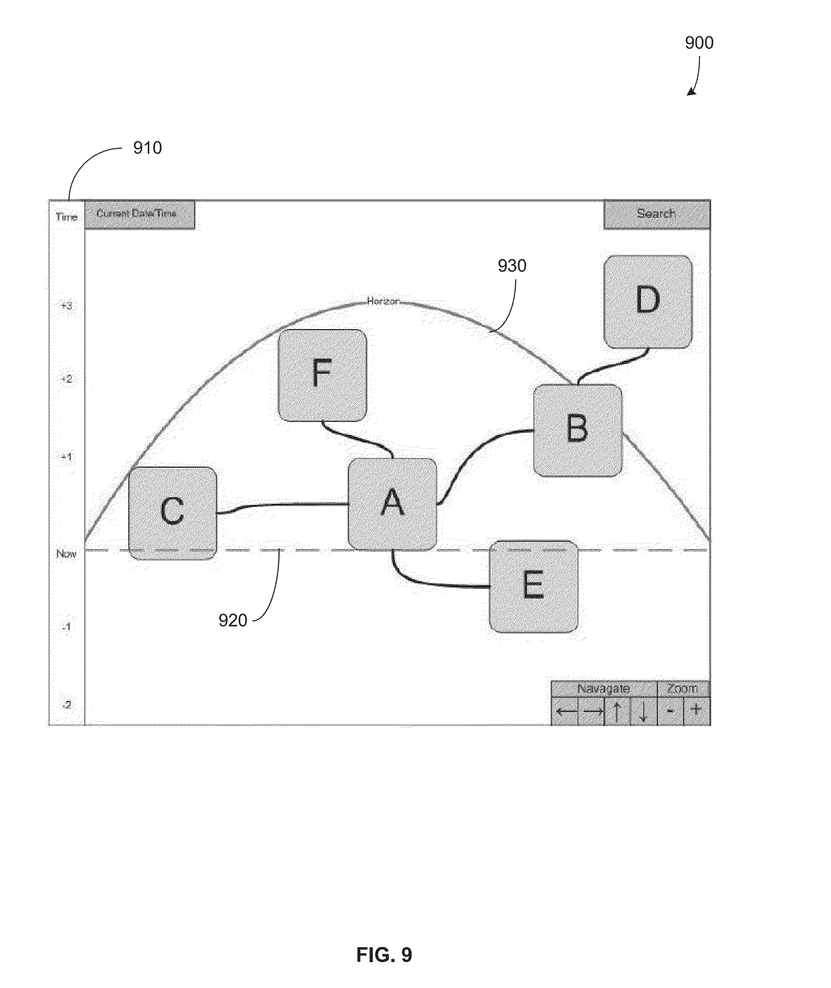

Such an embodiment can be navigated by a user interface (UI) such as that shown in FIG. 9. Here, a main event A is initially selected as a recommendation to the user, by virtue of either a relatively superior weight, or the user's selection. Time is shown from bottom to top on vertical axis 910. This UI 900 may have a line 920 that represents the current point in time, and a curve 930 “out ahead” that represents the horizon for that day, identifying future events of possible interest. Then there are other events through which a user can browse, related to event A (as indicated by the lines connecting the events) in current time or forward towards the horizon.

The user is able to scroll forward in time to discover future events. If event A is the last 49ers football game at Candlestick Park on Monday December 23^{th}, event E may be adjacent or slightly lower than event A. Event E is connected to event A because E is a related pregame ceremony/tailgate party, before the game A, in the parking lot of Candlestick Park. Then to the left there is another event (C), a gathering of fans to watch the game and have their own festivities at a favorite bar four blocks away from Candlestick. Then at another bar there may be another 49er fan event, in Burlingame a few miles away, and another in San Jose (50 miles away) where another fan group has congregated. Each event may be related in different and varying ways and degrees. So the graph shows the main event center horizon and branches of the graph show related events to each side forward and backward in time.

The more shared characteristics the related event has to the center event (or the heavier weight), the closer it is to the center event on the graph. If the user scrolls forward/up, i.e., forward in time, he may see events later on that evening after the game (such as events B and F). If he scrolls back in time the user may see events that already occurred. If the user scrolls right or left there may be events that are at the same time that have similar or different characteristics (such as location or strength of relation). The user always has the option to select any of the events as the new center horizon event. But the graph represents the relation that the events have to each other (and, in an embodiment, the relation to each other and to the user) as opposed to only a relation the event has towards the user. This allows the user to browse related events.

The user may also be able to zoom out and see a map where they can see 49er fan events in Las Vegas. Or the user can search for a particular event such as the Baltimore Ravens game on Sunday, and select that game to be the center of the horizon 930; he can then see what appears in the graph as adjacent related events. As already described above, there are many ways for the center horizon event to be selected. It could be user selected and searched for, or recommended by a recommendation engine. If a center horizon is determined, now the user can explore its “surroundings”, i.e., related events, and perform event discovery.

Note that the units for the time axis 910 may vary in different embodiments. The units may be hours, days, or weeks for example and without limitation. In an embodiment, the units may change to smaller units if a zoom function is used to focus on a smaller time window. In such a case, after zooming in, it may be more useful to calibrate this axis in hours instead of days, for example. Alternatively or in addition, the units for the time axis 910 may be selectable by the user.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including at least one computer readable medium having computer program logic stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, or other data storage device.

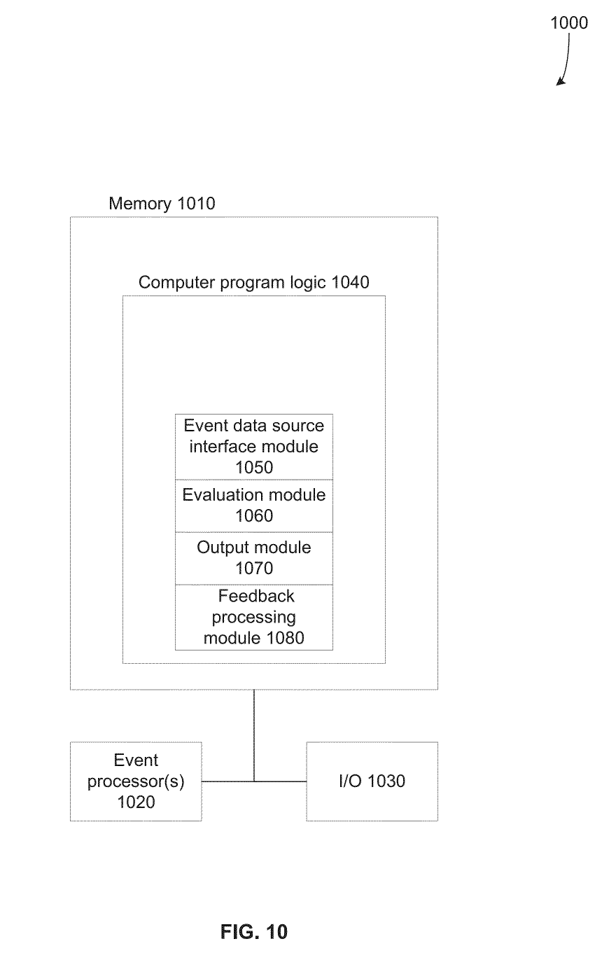

In an embodiment, some or all of the processing described herein may be implemented as software or firmware. Such a software or firmware embodiment at a server is illustrated in the context of a computing system 1000 in FIG. 10. System 1000 can represent a server, and includes one or more central processing unit(s) (CPU), shown as processor(s) 1020 acting as the event processor. System 1000 includes a body of memory 1010 that includes one or more non-transitory computer readable media that store computer program logic 1040. Memory 1010 may be implemented as a read-only memory (ROM) or random access memory (RAM) device, for example. Processor(s) 1020 and memory 1010 may be in communication using any of several technologies known to one of ordinary skill in the art, such as a bus or a point-to-point interconnect. Computer program logic 1040 contained in memory 1010 may be read and executed by processor(s) 1020. In an embodiment, one or more I/O ports and/or I/O devices, shown collectively as I/O 1030, may also be connected to processor(s) 1020 and memory 1010. In an embodiment, I/O 1030 may include the communications interface to one or more user devices and one or more event data sources.

In the embodiment of FIG. 10, computer program logic 1040 includes a module 1050 responsible for interfacing with event data sources. Computer program logic 1040 also includes a module 1060 responsible for evaluation of an event as shown in FIGS. 3 and 4. Computer program logic 1040 also includes a module 1070 responsible for outputting an identified event to a user device. Computer program logic 1040 may also include a module 1070 responsible for receiving and processing feedback from the user. As discussed above, processing of the feedback includes training of event evaluation logic.

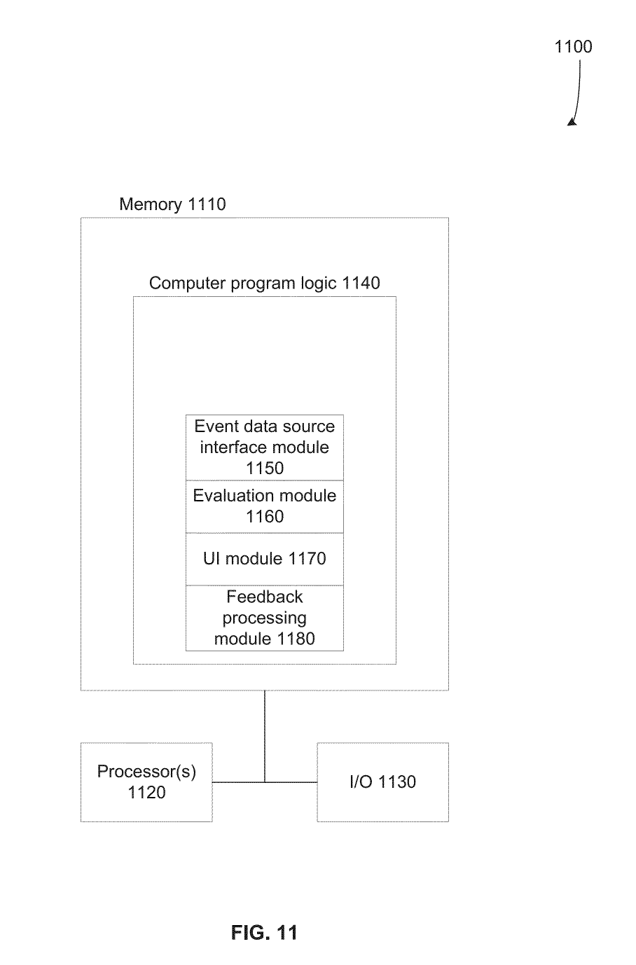

A software or firmware embodiment of functionality at the user device is illustrated in the context of a computing system 1100 in FIG. 11. System 1100 at the user device includes one or more central processing unit(s), shown as processor 1120. Processor 1120 represents the event processor. In an embodiment, processor 1120 also performs the duties of the UI processor; alternatively, the event processor and the UI processor may be distinct components. System 1100 also includes a body of memory 1110 that includes one or more non-transitory computer readable media that store computer program logic 1140. Memory 1110 may be implemented as a read-only memory (ROM) or random access memory (RAM) device, for example. Processor(s) 1120 and memory 1110 may be in communication using any of several technologies known to one of ordinary skill in the art, such as a bus or a point-to-point interconnect. Computer program logic 1140 contained in memory 1110 may be read and executed by processor(s) 1120. In an embodiment, one or more I/O ports and/or I/O devices, shown collectively as I/O 1130, may also be connected to processor(s) 1120 and memory 1110. In an embodiment, I/O 1130 may include the communications interface to the event data sources and audio/video output of the user device.

In the embodiment of FIG. 11, computer program logic 1140 includes a module 1150 responsible for interfacing with event data sources. Computer program logic 1140 also includes a module 1160 responsible for evaluation of an event as shown in FIGS. 3 and 4. Computer program logic 1140 may also include a module 1170 that implements a UI for showing an identified event to the user (as shown in FIG. 7, for example) and collecting feedback (as shown in FIGS. 7 and 8, for example). Computer program logic 1140 may also include a module 1180 responsible for receiving and processing feedback from the user. As discussed above, this latter processing includes training of event evaluation logic in an embodiment.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method of indicating events of interest to a user comprising:
at a server, receiving event data from one or more event data sources;
identifying an event to be indicated to a user device based on the event data;
indicating the identified event to a user device;
receiving, via the user device, feedback regarding the identified event; and
using the feedback to train future event identification.

2. The method of claim 1,
wherein the events compromise one or more of entertainment events and social events; and
wherein said event data sources comprise one or more of
online information sources for upcoming entertainment events, and
social media information sources.

3. The method of claim 1, wherein the event data compromises one or more of:
a location of an event;
a time for the event;
a category for the event;
a performer at the event; and
an attendee of the event.

4. The method of claim 1, further comprising:
indicating, to the user device, relationships between events, wherein the relationships between events are based on common features of the events.

5. The method of claim 1, further comprising:
receiving a user profile of the user of the user device,
performed before said identification of an event, wherein said identification of an event is further based on the user profile.

6. The method of claim 1 wherein, the feedback comprises acceptance or rejection of an identified event by a user of the user device.

7. The method of claim 1, wherein the feedback comprises a statement of a user preference regarding said identification.

8. The method of claim 1,
wherein said identification is performed using an artificial neural network, and
wherein training of future event identification comprises training of the neural network.

9. A system for indicating events of interest to user, comprising:
a processor; and
a memory in communication with said processor, said memory for storing a plurality of processing instructions for directing said processor to:
receive event data from one or more event data sources;
identify an event to be indicated to a user device based on the event data;
indicate the identified event to the user device;
receive, via the user device, feedback regarding the identified event; and
use the feedback to train future event identification.

10. The system of claim 9,
wherein the events compromise one or more of entertainment events and social events; and
wherein said event data sources comprise one or more of
online information sources for upcoming entertainment events, and
social media information sources.

11. The system of claim 9, wherein the event data compromises one or more of:
a location of an event;
a time for the event;
a category for the event;
a performer at the event; and
an attendee of the event.

12. The system of claim 9, wherein said instructions further direct said processor to:
indicate, to the user device, relationships between events, wherein the relationships between events are based on common features of the events.

13. The system of claim 9, wherein said instructions further direct said processor to:
receive a user profile of the user of the user device,
performed before the identification of an event, wherein said identification of an event is further based on the user profile.

14. The system of claim 9, wherein, the feedback comprises acceptance or rejection of an identified event by a user of the user device.

15. The system of claim 9, wherein the feedback comprises a statement of a user preference regarding the identification.

16. The system of claim 9,
wherein the identification is performed using an artificial neural network, and
wherein training of future event identification comprises training of the neural network.

17. A computer program product for indicating events of interest to a user, including a non-transitory computer readable medium having computer program logic stored therein, the computer program logic comprising:
logic for receiving event data from one or more event data sources;
logic for identifying an event to be indicated to a user device based on the event data;
logic for indicating the identified event to the user device;
logic for receiving, via the user device, feedback regarding the identified event; and
logic for using the feedback to train future event identification.

18. The computer program product of claim 17,
wherein the events compromise one or more of entertainment events and social events; and
wherein said event data sources comprise one or more of
online information sources for upcoming entertainment events, and
social media information sources.

19. The computer program product of claim 17, wherein the event data compromises one or more of:
a location of an event;
a time for the event;
a category for the event;
a performer at the event; and
an attendee of the event.

20. The computer program product of claim 17, the computer program logic further comprising:
logic for indicating, to the user device, relationships between events, wherein the relationships between events are based on common features of the events.

21. The computer program product of claim 17, the computer program logic further comprising:
logic for receiving a user profile of the user of the user device,
performed before the identification of an event, wherein the identification of an event is further based on the user profile.

22. The computer program product of claim 17 wherein, the feedback comprises acceptance or rejection of an identified event by a user of the user device.

23. The computer program product of claim 17, wherein the feedback comprises a statement of a user preference regarding the identification.

24. The computer program product of claim 17,
wherein the identification is performed using an artificial neural network, and
wherein the training of future event identification comprises training of the neural network.
